(19) United States
(12) Patent Application Publication
(10) Pub. No.: US 2011/0119010 A1
(43) Pub. Date: May 19, 2011

(54) METHOD OF DETERMINING CHARACTERISTICS OF DEVICE UNDER TEST, PROGRAM, AND STORAGE MEDIUM STORING PROGRAM

(75) Inventor: Junichi Yuki, Tokyo (JP)

(73) Assignee: ADVANTEST CORPORATION, Tokyo (JP)

(21) Appl. No.: 13/003,405

(22) PCT Filed: Jan. 15, 2009
(86) PCT No.: PCT/JP2009/050446

§ 371 Date: Jan. 10, 2011

(51) Int. Cl. G06F 19/00

(52) U.S. Cl. 702/82

(57) ABSTRACT

A method of determining characteristics of a DUT, in which test results indicating at least a pass/fail state of the DUT are used on a matrix in which plots defined by a combination of a first test parameter and a second test parameter for testing the DUT are arranged two-dimensionally, includes the steps of: (a) specifying at least one plot pair constituted by adjacent plots but indicating different test results on the matrix; (b) specifying test results of a plot pair constituted by adjacent plots and located next to both plots of the plot pair specified in the step (a); (c) selecting a plot pair constituted by adjacent plots but indicating different test results in a region including the plot pair specified in the step (a) and the step (b); and (d) specifying test results of a plot pair constituted by adjacent plots and located next to both plots of the plot pair selected in the step (c).

### BACKGROUND

1. Technical Field

The present invention relates to a method and a program for determining characteristics of a device under test, and a storage medium storing the program.

2. Related Art

A shmoo tool employed in a GUI tool is known as a tool for determining characteristics of a device under test (DUT). The shmoo tool indicates a pass/fail state and so on of the device under test on a matrix on which plots defined by combinations of first and second test parameters relating to the device under test are arranged two-dimensionally, and by performing a test using this tool, the characteristics of the device under test, such as design objectives, operating margins, and so on of the device, can be determined easily.

A so-called sequential system, in which the pass/fail state is indicated in relation to each plot from a plot start point to a plot end point, is widely used in the related art as a method of determining the characteristics of a DUT using a shmoo tool.

In another known method, as disclosed in the specification of U.S. Pat. No. 6,795,788, a pass/fail boundary of the matrix is specified without indicating the pass/fail state of every plot.

However, when the sequential system is used, test results are specified in relation to all of the plurality of plots arranged on the matrix, and therefore test results are specified in relation to a large number of plots that bear no relation to the pass/fail boundary of the matrix. As a result, a large amount of time is expended on the test. When a large number of test parameter variables is employed, or in other words when the number of plots on the matrix increases, this problem becomes more serious.

Furthermore, some users may only need to know only the pass/fail boundary of the matrix, and with this conventional method, such users waste a large amount of time on the test.

According to the method described in the specification of U.S. Pat. No. 6,795,788, on the other hand, a user finds an initial pass/fail boundary by selecting an arbitrary plot as a start point and specifying the pass/fail state of each subsequent plot until the pass/fail boundary is found, and therefore, in certain cases, test results must be specified in relation to a large number of plots that bear no relation to the pass/fail boundary. Furthermore, after finding the initial pass/fail boundary, the user finds a subsequent pass/fail boundary by setting an adjacent plot to the initial pass/fail boundary as an origin and specifying the pass/fail state of each plot on the periphery thereof until the next pass/fail boundary is found. Hence, in this case also, the user may have to specify test results relating to a large number of plots that bear no relation to the pass/fail boundary. Therefore, the test time cannot be reduced effectively even by applying the method disclosed in the above specification.

### SUMMARY

It is therefore an object of the present invention to provide a method and a program for determining characteristics of a device under test with which the problems described above can be solved, as well as a storage medium for storing the program. This object is achieved by combining features described in the independent claims. The dependent claims define further advantageous specific examples of the present invention.

An aspect of a method of determining characteristics of a device under test according to the present invention, in which test results indicating at least a pass/fail state of the device under test are used on a matrix in which plots defined by a combination of a first test parameter and a second test parameter for testing the device under test are arranged two-dimensionally, includes the steps of: (a) specifying at least one plot pair constituted by adjacent plots but indicating different test results on the matrix; (b) specifying test results of a plot pair constituted by adjacent plots and located next to both plots of the plot pair specified in the step (a); (c) selecting a plot pair constituted by adjacent plots but indicating different test results in a region including the plot pairs specified in the step (a) and the step (b); and (d) specifying test results of a plot pair constituted by adjacent plots and located next to both plots of the plot pair selected in the step (c).

The method may also include the step of (e) shifting the region to include the plot pair selected in the step (c) and the plot pair specified in the step (d).

The method may also include the steps of: (f) selecting a plot pair constituted by adjacent plots but indicating different test results from the shifted region; (g) specifying a plot pair constituted by adjacent plots and located next to both plots of the plot pair selected in the step (f); (h) shifting the region further to include the plot pair selected in the step (f) and the plot pair specified in the step (g); and (i) repeating the steps (f) to (h) until [the region is] adjacent to a plot of a maximum value or a minimum value of the first or second test parameter on the matrix.

The step (a) may include displacing a value of the second test parameter relative to a single value of the first test parameter to specify the test results of the plot pairs.

The step (a) may also include displacing at least the second test parameter such that a maximum value and a minimum value are selected.

The step (a) may also include the steps of: (a1) specifying a test result of a plot selected from the second test parameter; (a2) displacing the second test parameter such that at least one plot is skipped; and (a3) specifying a test result of a plot selected by displacing the second test parameter.

The step (a) may also include the steps of: (a4) comparing the test results of the two plots; (a5) displacing the value of the second test parameter in an opposite direction when, as a result of the step (a4), the two test results are different, and displacing the value of the second test parameter further in an identical direction when the two test results are identical; (a6) specifying a test result of a plot selected by displacing the second test parameter; and (a7) repeating the steps (a4) to (a7) until a plot pair constituted by adjacent plots but indicating different test results is specified.

The method may also include the steps of: performing each of the steps in relation to test results from the device under test tested under a first test condition to obtain the plots specifying the test results; obtaining test results from the device under test tested under a second test condition, which differs from the first test condition, in the plots obtained under the first test condition; and determining the characteristics by comparing the test results obtained under the first test condition with the test results obtained under the second test condition.

Further, in an aspect of a program according to the present invention for causing a computer to execute a method of determining characteristics of a device under test, in which test results indicating at least a pass/fail state of the device under test are used on a matrix in which plots defined by a combination of a first test parameter and a second test parameter for testing the device under test are arranged two-dimensionally, the method includes the steps of: (a) specifying at least one plot pair constituted by adjacent plots but indicating different test results on the matrix; (b) specifying test results of a plot pair constituted by adjacent plots and located next to both plots of the plot pair specified in the step (a); (c) selecting a plot pair constituted by adjacent plots but indicating different test results in a region including the plot pairs specified in the step (a) and the step (b); and (d) specifying test results of a plot pair constituted by adjacent plots and located next to both plots of the plot pair selected in the step (c).

A computer-readable recording medium storing the program described above may also be provided.

Note that in this specification, the term “means” does not signify only physical means, but includes cases in which a function of the means is realized by software. Further, a function of singular means may be realized by two or more physical means, and the functions of two or more means may be realized by singular physical means.

### BRIEF DESCRIPTION OF THE DRAWINGS

FIG. 1 is a view showing a functional constitution of a system according to an embodiment of the present invention;

FIG. 2 is a view showing in detail a DUT plot specification control tool shown in FIG. 1;

FIG. 3 is a view showing a matrix displaying characteristics of a DUT, according to this embodiment of the present invention;

FIG. 4 is a flowchart showing an outline of a method of determining characteristics of a DUT according to this embodiment of the present invention;

FIG. 5 is a flowchart showing in detail a step S101 of FIG. 4;

FIG. 6 is a view showing an example of a matrix obtained by applying respective steps of the method of determining characteristics of a DUT according to this embodiment of the present invention;

FIG. 7 is a view showing an example of a matrix obtained by applying the respective steps of the method of determining characteristics of a DUT according to this embodiment of the present invention;

FIG. 8 is a view showing an example of a matrix obtained by applying the respective steps of the method of determining characteristics of a DUT according to this embodiment of the present invention;

FIG. 9 is a view showing an example of a matrix obtained by applying the respective steps of the method of determining characteristics of a DUT according to this embodiment of the present invention;

FIG. 10 is a view showing an example of a matrix obtained by applying the respective steps of the method of determining characteristics of a DUT according to this embodiment of the present invention;

FIG. 11 is a view showing an example of a matrix obtained by applying the respective steps of the method of determining characteristics of a DUT according to this embodiment of the present invention;

FIG. 12 is a view showing an example of a matrix obtained by applying the respective steps of the method of determining characteristics of a DUT according to this embodiment of the present invention;

FIG. 13 is a view showing an example of a matrix obtained by applying the respective steps of the method of determining characteristics of a DUT according to this embodiment of the present invention;

FIG. 14 is an enlarged view showing a matrix in the vicinity of coordinates of a plot pair specified in a step S101 of the method of determining characteristics of a DUT according to this embodiment of the present invention;

FIG. 15 is an enlarged view showing a matrix in the vicinity of coordinates of a plot pair specified in a step S101 of the method of determining characteristics of a DUT according to this embodiment of the present invention;

FIG. 16 is an enlarged view showing a matrix in the vicinity of coordinates of a plot pair specified in a step S101 of the method of determining characteristics of a DUT according to this embodiment of the present invention;

FIG. 17 is an enlarged view showing a matrix in the vicinity of coordinates of a plot pair specified in a step S101 of the method of determining characteristics of a DUT according to this embodiment of the present invention;

FIG. 18 is a view showing an example of a matrix obtained by applying the respective steps of the method of determining characteristics of a DUT according to this embodiment of the present invention;

FIG. 19 is a view showing an example of a matrix obtained by applying the respective steps of the method of determining characteristics of a DUT according to this embodiment of the present invention;

FIG. 20 is a view showing an example of a matrix obtained by applying the respective steps of the method of determining characteristics of a DUT according to this embodiment of the present invention;

FIG. 21 is a view illustrating a method of determining characteristics of a DUT according to a modified example of this embodiment of the present invention, and specifically shows a matrix obtained under a first test condition;

FIG. 22 is a view illustrating the method of determining characteristics of a DUT according to the modified example of this embodiment of the present invention, and specifically shows a matrix obtained under a second test condition in which test results of all plots are specified;

FIG. 23 is a flowchart showing the method of determining characteristics of a DUT according to the modified example of this embodiment of the present invention;

FIG. 24 is a view showing an example of a matrix obtained by applying respective steps of the method of determining characteristics of a DUT according to the modified example of this embodiment of the present invention;

FIG. 25 is a view showing an example of a matrix obtained by applying the respective steps of the method of determining characteristics of a DUT according to the modified example of this embodiment of the present invention; and

FIG. 26 is a view illustrating the method of determining characteristics of a DUT according to the modified example of this embodiment of the present invention, and specifically shows a matrix obtained finally under the first and second test conditions.

### DESCRIPTION OF EXEMPLARY EMBODIMENTS

An embodiment of the present invention will be described below with reference to the drawings. Note, however, that the embodiment described below does not limit the inventions described in the claims, and combinations of features described in the embodiment do not all necessarily constitute means for solving the problems of the present invention.

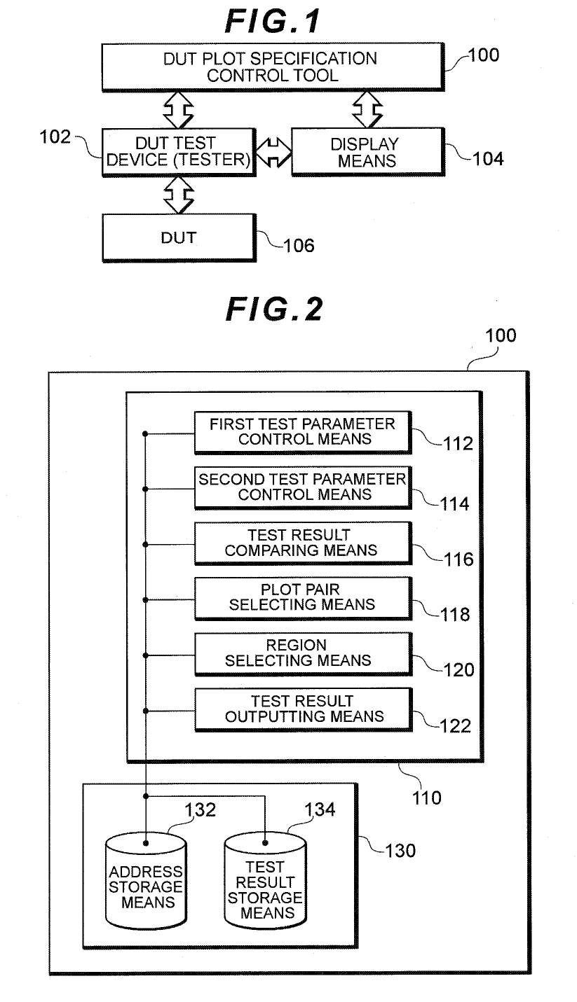

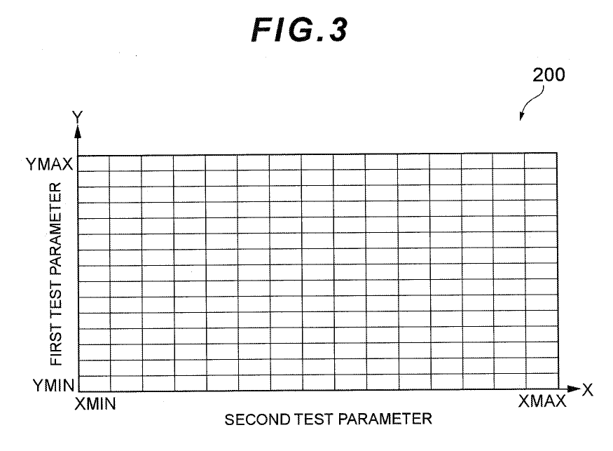

First, referring to FIGS. 1 to 3, a system used to execute a method of determining characteristics of a device under test according to an embodiment of the present invention will be described. Here, FIG. 1 is a view showing a functional constitution of the system according to this embodiment, FIG. 2 is a view showing in detail a DUT plot specification control tool 100 shown in FIG. 1, and FIG. 3 is a view showing a matrix displaying characteristics of a DUT.

As shown in FIG. 1, the system according to this embodiment mainly includes the plot specification control tool 100, a DUT test device (tester) 102, and display means 104.

The plot specification control tool 100 is a recording medium in which a predetermined program for executing the method of determining characteristics of a DUT according to this embodiment is installed in advance. The plot specification control tool 100 mainly includes control means 110 for controlling processing required to determine DUT characteristics, and storage means 130 for storing information required in the processing. The plot specification control tool 100 may be incorporated into a shmoo tool employed in a GUI tool, or may be constituted independently of a shmoo tool. Further, the plot specification control tool 100 is connected accessibly to the DUT test device (tester) 102 so that it can be operated on the basis of information from the DUT test device 102, for example. The information from the DUT test device 102 includes a test condition, first and second parameters, DUT test results, and so on.

The DUT test device 102 tests at least one DUT 106. More specifically, the DUT test device 102 generates a predetermined test signal using first and second test parameters, supplies the test signal to the DUT 106, and tests the pass/fail state and so on of the DUT 106 on the basis of whether or not an output signal, which is output when the DUT 106 is operated in accordance with the test signal under a predetermined test condition, is within an expected value range. The DUT test device 102 is realized by an open architecture, and a module based on an open architecture may be used as a test module for supplying the test signal to the DUT 106. The DUT test device 102 and the DUT plot specification control tool 100 are connected accessibly to the display means 104, which is a display or the like, so that results obtained by the DUT test device 102 and the DUT plot specification control tool 100 can be displayed on the display means 104.

The plot specification control tool 100 performs control to determine whether or not a certain plot needs to be specified in order to display a test result indicating at least the pass/fail state of a DUT on a matrix 200 shown in FIG. 3. Here, the pass/fail state of the DUT indicates whether or not an output value of the DUT is within a predetermined expected value range. In addition to “pass” or “fail”, the test result may indicate “out of range”, for example.

As shown in FIG. 3, the matrix 200 is formed by arranging plots defined by a combination of the first and second test parameters used to test the DUT two-dimensionally. By specifying the pass/fail state and so on of the DUT on the basis of values of the respective test parameters on the matrix 200, an operating range, or in other words a pass/fail boundary, of the DUT can be learned. A plot is specified on the matrix 200 internally by the DUT plot specification control tool 100, whereupon the specified plot is displayed on the display means 104 so that it can be viewed by a user.

In the example shown in FIG. 3, the first test parameter is displaceable in a Y direction, the second test parameter is displaceable in an X direction, and X, Y coordinates, or in other words a single plot, can be specified from the respective values thereof. Here, the term “the test parameter is displaceable” means that a tested parameter relating to the DUT can be selected or obtained. More specifically, this means that the DUT test device 102 has already tested the DUT 106 on the basis of the first and second test parameters, and information obtained as a result of the test can be selected or obtained by displacing the first and second test parameters. Further, the term “the test parameter is displaceable” means not only that parameter values can be selected in sequence, but also that a plurality of values can be selected simultaneously and that a plurality of values can be selected at random or in a predetermined arrangement. In the example shown in FIG. 3, a plurality of values from a minimum value to a maximum value of the first test parameter are allocated in the direction of an arrow indicating a Y axis of the matrix 200, and a plurality of values from a minimum value to a maximum value of the second test parameter are allocated in the direction of an arrow indicating an X axis of the matrix 200. In the example shown in FIG. 3, fifteen plots are provided in the Y direction so that the first test parameter has fifteen values, and fifteen plots are provided in the X direction so that the second test parameter has fifteen values. Accordingly, FIG. 3 shows a matrix constituted by a total of 225 plots.

Note that the matrix 200 is not limited to the form shown in FIG. 3, and there are no limits on the number of plots in each of the X and Y directions. Further, the number of plots in the X direction may be identical or different to the number of plots in the Y direction. Moreover, the first test parameter may be defined in the X direction and the second test parameter may be defined in the Y direction.

The first and second test parameters are parameters used in a test performed by the DUT test device 102. Examples of combinations of the first and second test parameters include a combination of a timing value indicating a timing at which a logic value of an input signal input into the DUT 106 varies and an operating voltage of the DUT 106, a combination of a frequency and a power supply voltage of the DUT 106, and a combination of timing value automatic tracking (a function for scanning timing values of all pins automatically during a frequency scan) and level value automatic tracking (a function for scanning level values of all pins automatically during a frequency scan).

A general purpose computer including a CPU, a ROM, a RAM, an external storage device, a user interface, a display, a printer, a communication interface, and so on may be applied as the hardware constitution of the DUT plot control tool 100. By having the CPU of the DUT plot control tool 100 execute a predetermined program (a program defining the method for determining characteristics of a DUT according to this embodiment) that is stored in the aforementioned ROM, RAM, external storage device, or the like or downloaded via a communication network, for example, the DUT plot control tool 100 can be caused to function as various function realizing means (FIG. 2) or various steps.

As shown in FIG. 2, the control means 110 mainly include first test parameter control means 112 for controlling first test parameter displacement and value selection, second test parameter control means 114 for controlling second test parameter displacement and value selection, test result comparing means 116 for comparing test results of plots, plot pair selecting means 118 for selecting predetermined plot pairs, region selecting means 120 for selecting and shifting a reference region, and test result outputting means 122 for outputting test results obtained in various steps. The various function realizing means are connected accessibly to the storage means 130 such that data required to determine the characteristics of a DUT that has been processed by the respective means described above can be stored in or read from the storage means 130. The various realizing means will be described below while describing the method of determining characteristics of a DUT.

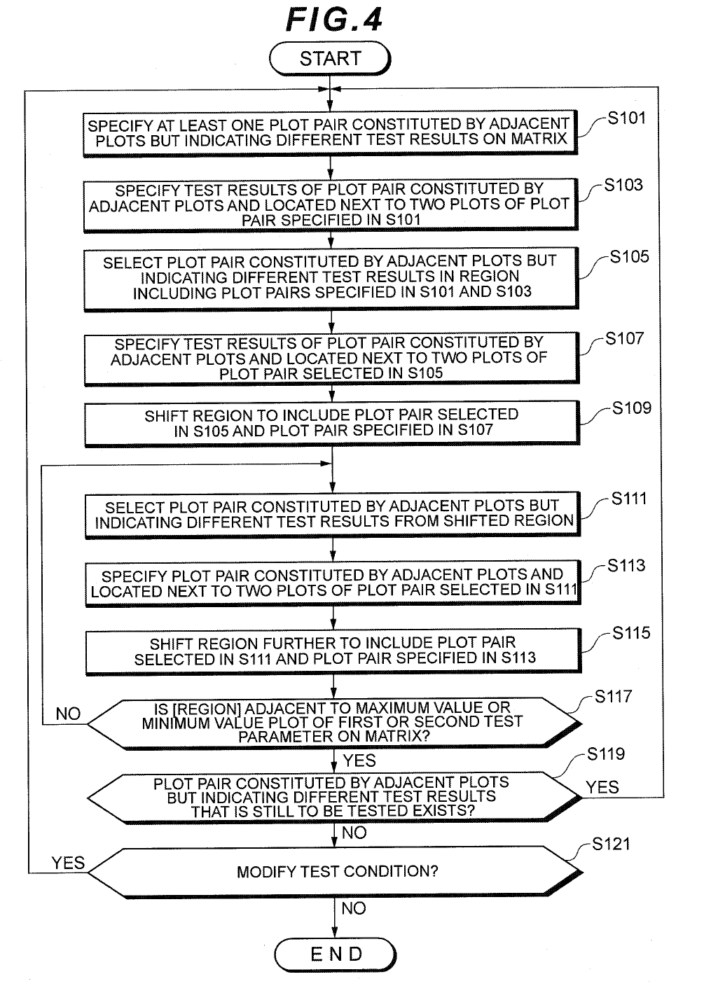

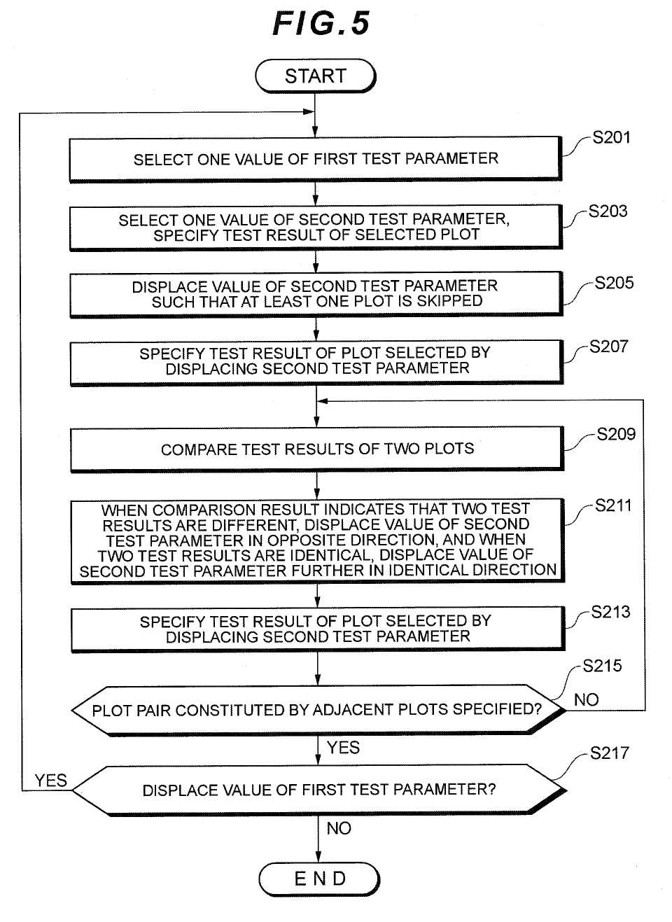

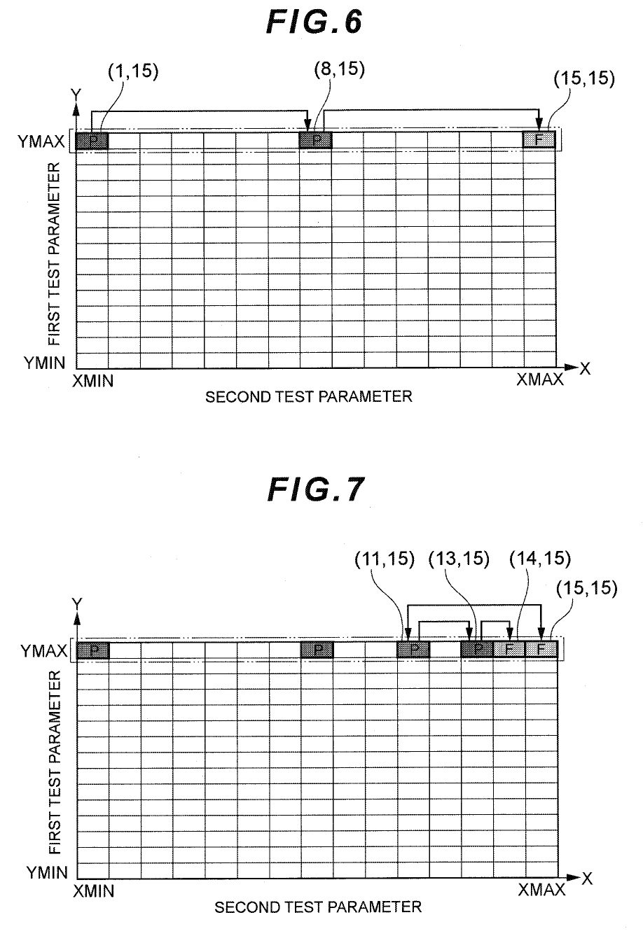

Next, referring to flowcharts shown in FIGS. 4 and 5 and matrices shown in FIGS. 6 to 20, the method of determining characteristics of a DUT according to one embodiment of the present invention will be described.

Here, FIG. 4 is a flowchart showing an outline of the method of determining characteristics of a DUT according to this embodiment, FIG. 5 is a flowchart showing in detail a step S101 of FIG. 4, and FIGS. 6 to 20 are views showing examples of matrices obtained by applying respective steps of the method of determining characteristics of a DUT according to this embodiment.

Note that in each of the following steps, a pass/fail combination is applied as a combination of different test results. As a modified example, however, respective combinations of pass/fail, pass/out of range, and fail/out of range may be applied.

Further, the steps in the flowcharts to be described below (including partial steps not allocated a reference number) may be rearranged or executed in parallel as desired within a scope that does not contradict the processing content. Moreover, the processing to be described below with reference to the drawings may be realized on the basis of control performed by the control means 110 by executing steps defined in the predetermined program read from the storage means 130.

First, as shown in FIG. 4, at least one plot pair constituted by adjacent plots and indicating different test results is specified on the matrix 200 (S101). For example, the plot pair may be specified by displacing the value of the second test parameter using the second test parameter control means 114 in relation to a single value of the first test parameter selected by the first test parameter control means 112. In this case, the second test parameter may be displaced such that at least a maximum value XMAX and a minimum value XMIN are selected.

More specifically, as shown in FIGS. 5 and 6, first, a single value of the first test parameter is selected (S201). In other words, a single Y coordinate is selected on the matrix 200. In this case, a maximum value (Y=15) of the first test parameter may be selected.

Next, a single value of the second test parameter is selected, and the test result of the selected plot is specified (S203). In other words, a single X coordinate is selected in relation to the Y coordinate selected on the matrix 200, and a single plot is specified thereby. For example, a minimum value (X=1) of the second test parameter is selected in relation to the maximum value (Y=15) of the first test parameter such that a plot (1, 15) is specified. In the example shown in FIG. 6, the test result of the plot (1, 15) is a pass (P).

Note that an address and the test result of the specified plot are stored in address storage means 132 and test result storage means 134, respectively.

Next, the second test parameter is displaced such that at least one plot is skipped (S205). Here, the term “at least one plot is skipped” means that a removed plot is selected. In other words, the second test parameter is displaced such that any of plots (3, 15) to (15, 15), i.e. any plot other than an adjacent plot (2, 15) to the plot (1, 15), is selected. For example, if the X coordinate of the initially selected plot (1, 15) is set as X1 and the maximum value of the second test parameter is set as XMAX, the value of the second test parameter may be displaced such that an X coordinate of (X1+XMAX)/2 is selected when (X1+XMAX) is an even number and an X coordinate of {(X1+XMAX)+1}/2 or {(X1+XMAX)−1}/2 is selected when (X1+XMAX) is an odd number. In the example shown in FIG. 6, X1=1 and XMAX=15, and therefore the second test parameter is displaced such that a plot (8, 15), for example, is selected. By displacing the second test parameter such that at least one plot is skipped in this manner, a plot pair constituted by adjacent plots but indicating different test results can be found efficiently from a small number of plots.

Alternatively, in a case where the maximum value (X=15) of the second test parameter is selected in the step S201, the value of the second test parameter may be displaced in the step S205 such that if the minimum value of the second test parameter is set as XMIN, an X coordinate of (X1+XMIN)/2 is selected when (X1+XMIN) is an even number and an X coordinate of {(X1+XMIN)+1}/2 or {(X1+XMIN)−1}/2 is selected when (X1+XMIN) is an odd number.

Next, the test result of the plot selected by displacing the second test parameter is specified (S207). In the example shown in FIG. 6, the test result of the plot (8, 15) is a pass (P).

The test results of the two plots obtained in this manner are then compared by the test result comparing means 116, for example (S209). When, as a result of the comparison, the test results of the two plots are found to be different, the value of the second test parameter is displaced in an opposite direction, and when the test results of the two plots are identical, the value of the second test parameter is displaced further in the same direction (S211). In the example shown in FIG. 6, the plot (1, 15) and the plot (8, 15) both indicate a pass (P), and since the test results of the two plots are identical, the value of the second test parameter is displaced further in the same direction, i.e. a direction for increasing the X value. In this case, the second test parameter may be displaced such that at least one plot is skipped or such that the adjacent plot is selected. In the example shown in FIG. 6, the second test parameter is displaced such that a plot (15, 15) is selected next.

Next, the test result of the plot selected by displacing the second test parameter is specified (S213). In the example shown in FIG. 6, the test result of the plot (15, 15) is a fail (F).

Next, a determination is made as to whether or not a plot pair constituted by adjacent plots has been specified (S215). When a plot pair constituted by adjacent plots has not been specified, the steps S209 to S215 are performed repeatedly until a plot pair constituted by adjacent plots is specified. In the example shown in FIG. 6, a plot pair constituted by adjacent plots has not yet been specified, and therefore the routine returns to the step S209.

In the step S209, the test results of the two plots are compared. In other words, the test results of the two most recently specified plots are compared. The plot (8, 15) indicates a pass (P), whereas the plot (15, 15) indicates a fail (F), and therefore the test results of the two plots are different. Hence, in the step S211, the value of the second test parameter is displaced in the opposite direction, i.e. a direction for reducing the X value. In this case, as noted above, the second test parameter may be displaced such that at least one plot is skipped or such that the adjacent plot is selected. For example, if the X coordinate of a current plot is set as Xn and the X coordinate of the plot for which the test result has already been found in the displacement direction of the second test parameter is set as Xm, the value of the second test parameter may be displaced such that an X coordinate of (Xn+Xm)/2 is selected when (Xn+Xm) is an even number and an X coordinate of {(Xn+Xm)+1}/2 or {(Xn+Xm)−1}/2 is selected when (Xn+Xm) is an odd number. In an example shown in FIG. 7, the second test parameter is displaced such that a plot (11, 15) is selected next.

In the step S213, the test result of the plot selected by displacing the second test parameter is specified. In the example shown in FIG. 7, the test result of the plot (11, 15) is a pass (P).

Next, in the step S215, a determination is made as to whether or not a plot pair constituted by adjacent plots has been specified, but in the example shown in FIG. 7, a plot pair constituted by adjacent plots has not yet been specified, and therefore the routine returns to the step S209 again.

In the step S209, the test results of the two most recently specified plots are compared again. In this case, the plot (11, 15) indicates a pass (P) and the plot (13, 15) also indicates a pass (P), and therefore the test results of the two plots are found to be identical in the step S211. Accordingly, the second test parameter is displaced further in the same direction, or in other words the direction for increasing the X value. In this case, the only plot that can be specified next is the plot (14, 15) adjacent to the plot (13, 15), and therefore the second test parameter is displaced such that the plot (14, 15) is selected. Next, in the step S213, the test result of the plot selected by displacing the second test parameter is specified. In the example shown in FIG. 7, the test result of the plot (14, 15) is a fail (F).

Hence, eventually, a plot pair (13, 15), (14, 15) constituted by adjacent plots but indicating different test results can be obtained. At this point, a plot pair constituted by adjacent plots is specified, and therefore the routine advances to a step S217.

Next, a different Y coordinate may be selected on the matrix 200 by displacing the value of the first test parameter (S217). More specifically, the step S101, or in other words the step for specifying at least one plot pair constituted by adjacent plots but indicating different test results, may be performed in relation to another Y coordinate.

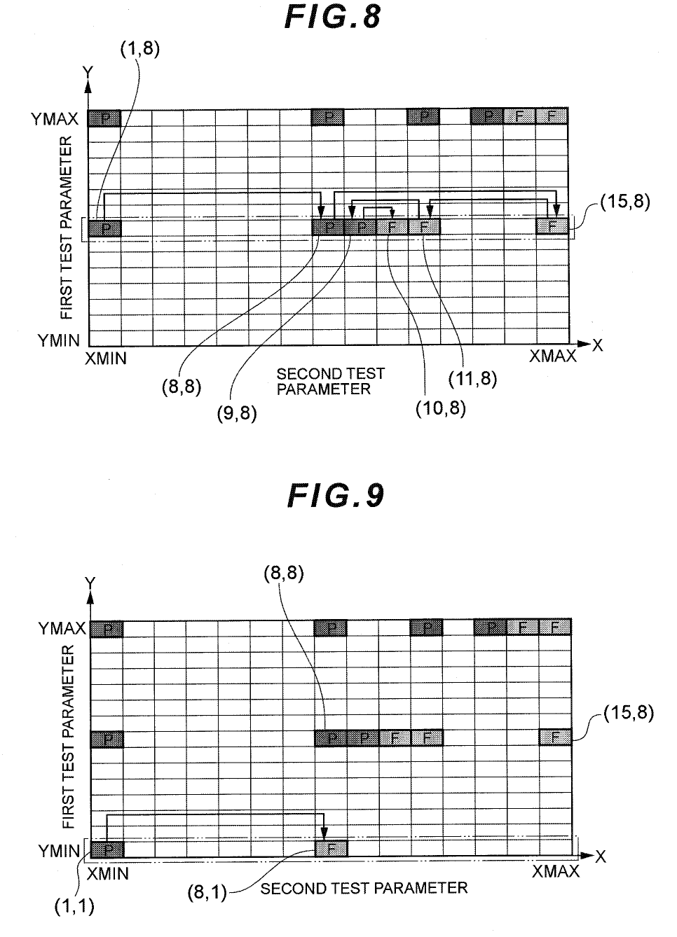

First, in accordance with the step S201, another Y coordinate is selected on the matrix 200 by displacing the value of the first test parameter. For example, if the Y coordinate specified in the first step S101 is set as Y0 and a minimum value of the first test parameter is set as YMIN, the value of the first test parameter may be displaced such that an X coordinate of (Y0+YMIN)/2 is selected when (Y0+YMIN) is an even number and a Y coordinate of {(Y0+YMIN)+1}/2 or {(Y0+YMIN)−1}/2 is selected when (Y0+YMIN) is an odd number. In an example shown in FIG. 8, Y0=15 and YMIN=1, and therefore the first test parameter is displaced such that a plot (1, 8), for example, is selected. By specifying a plot indicating a test result in relation to another Y coordinate in this manner, a plot pair constituted by adjacent plots but indicating different test results can be found reliably.

Alternatively, in a case where the minimum value (Y=1) of the second test parameter is selected in the initial step S101, the value of the first test parameter may be displaced such that if the maximum value of the first test parameter is set as YMAX, an X coordinate of (Y0+YMAX)/2 is selected when (Y0+YMAX) is an even number and a Y coordinate of {(Y0+YMAX)+1}/2 or {(Y0+YMAX)−1}/2 is selected when (Y0+YMAX) is an odd number.

Next, the steps S203 to S217 are performed in relation to the selected value (Y=8) of the first test parameter, whereby a plot (1, 8) indicating a pass (P), a plot (8, 8) indicating a pass (P), a plot (15, 8) indicating a fail (F), a plot (11, 8) indicating a fail (F), a plot (9, 8) indicating a pass (P), and a plot (10, 8) indicating a fail (F) are specified in sequence, as shown in FIG. 8. Thus, a plot pair (9, 8), (10, 8) constituted by adjacent plots but indicating different test results can be obtained.

As a modified example, when the steps S203 to S217 are performed in relation to the selected value (Y=8) of the first test parameter and the test results of the first three selected plots, for example, differ from the test results of other plots having respectively identical X coordinates, a plot pair constituted by adjacent plots but indicating different test results may be specified between the two plots.

Next, a different Y coordinate is selected on the matrix 200 by displacing the value of the first test parameter (S217, S201), whereupon the step S101, or in other words the step for specifying at least one plot pair constituted by adjacent plots but indicating different test results, may be performed in relation to this Y coordinate.

In an example shown in FIG. 9, Y=1, or in other words YMIN, is selected next, whereupon the second test parameter is displaced such that a plot (1, 1) is selected. As shown in FIG. 9, by performing the respective steps for finding a plot pair constituted by adjacent plots but indicating different test results in relation to each of the maximum value YMAX, the minimum value YMIN, and an intermediate value (for example, Y=8) of the Y coordinate, the target plot pair can be found more reliably.

Next, the steps S203 to S215 are performed on the selected value (Y=1) of the first test parameter, whereby the plot (1, 1) indicating a pass (P) and the plot (8, 1) indicating a fail (F) are specified in sequence, as shown in FIG. 9.

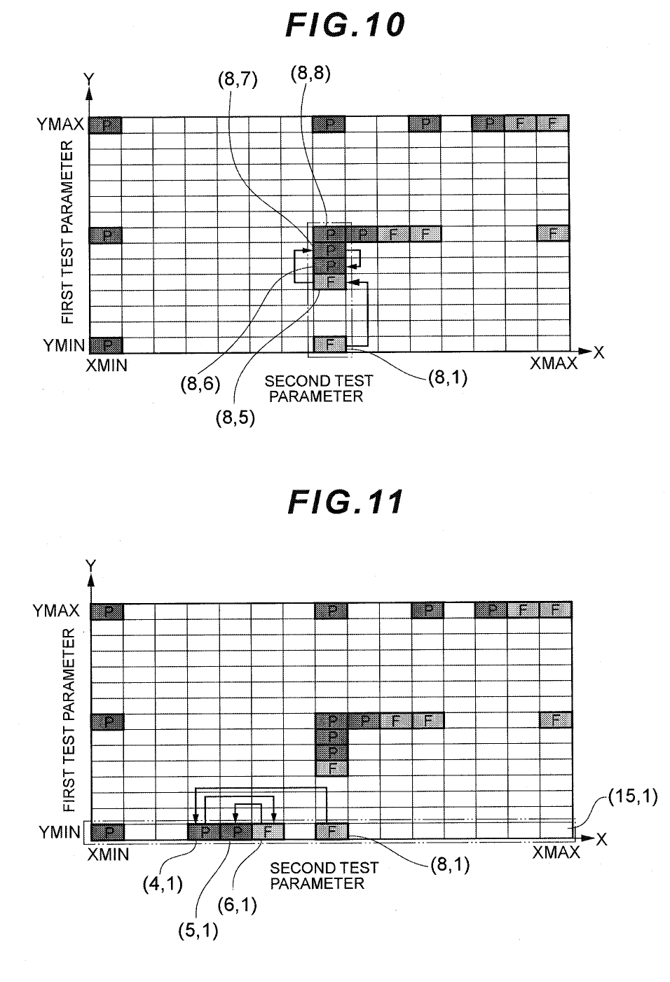

When a plot having a different test result exists at the same X coordinate as one of the plots specified in the above steps, a plot pair constituted by adjacent plots but indicating different test results may be specified between these two plots. To describe this using the example shown in FIG. 9, when the plot (8, 8) and the plot (8, 1), which have the same X coordinate, are compared, it is found that the former is a fail (F) while the latter is a pass (P), and therefore the test results of the two plots are different. Hence, a plot pair constituted by adjacent plots but indicating different test results is specified from the plots located between the plot (8, 1) and the plot (8, 8). In this case, the steps S203 to S215 may be applied after switching the first test parameter and second test parameter. As shown in FIG. 10, for example, by performing the respective steps described above, a plot (8, 5) indicating a fail (F), a plot (8, 7) indicating a pass (P), and a plot (8, 6) indicating a pass (P) are specified in sequence. As a result, a plot pair (8, 6), (8, 5) constituted by adjacent plots but indicating different test results can be obtained. Thus, a plot pair constituted by adjacent plots but indicating different test results can be found even more reliably.

Next, the routine returns to the position of the plot (8, 1), whereupon the step for specifying a plot pair constituted by adjacent plots but indicating different test results is executed again in relation to Y=1. More specifically, after returning to the position of the plot (8, 1), the steps from the step S209 (the step for comparing the test results of two plots) onward are executed. As a result, a plot (4, 1) indicating a pass (P), a plot (6, 1) indicating a fail (F), and a plot (5, 1) indicating a pass (P) are specified in sequence. Thus, a plot pair (5, 1), (6, 1) constituted by adjacent plots but indicating different test results can be obtained.

Once the respective steps are complete, a determination is made as to whether or not the test results of respective plots corresponding to the maximum value YMAX, an intermediate value (for example, X=8), or the minimum value YMIN of the second test parameter have been specified on the matrix 200 in relation to the maximum value XMAX, an intermediate value (for example, Y=8), or the minimum value XMIN of the first test parameter, and when it is found as a result of the determination that a plot for which the test result has not been specified exists, the test result of this plot may be specified. In an example shown in FIG. 11, the test result of a plot (15, 1) is not yet specified, and therefore the test result of the plot (15, 1) is specified, as shown in FIG. 12. The test result of the plot (15, 1) is a fail (F).

When the steps described above are complete, the step S101 shown in FIG. 4 is terminated. In the example shown in FIG. 12, a plurality of plot pairs constituted by adjacent plots but indicating different test results, namely the plot pair (13, 15), (14, 15), the plot pair (9, 7), (10, 7), the plot pair (8, 5), (8, 6), and the plot pair (5, 1), (6, 1), can be specified in the step S101. The obtained plot pairs are stored in the address storage means 132 and test result storage means 134 of the storage means 130, for example.

Hence, with the method of determining characteristics of a DUT according to this embodiment, a plurality of plot pairs constituted by adjacent plots but indicating different test results can be obtained by specifying a minimum number of plots. Therefore, the test time can be reduced greatly in comparison with a case in which the pass/fail states of the plots are specified one by one, using a plot selected arbitrarily by the user as an origin, until a pass/fail boundary is found.

When a plurality of plot pairs are specified in the step S101, one plot pair is selected to serve as a reference in subsequent steps. For example, the plot pair that corresponds to the maximum value or minimum value of the first or second test parameter may be selected. In FIG. 12, the plot pair (13, 15), (14, 15) and the plot pair (5, 1), (6, 1) are plot pairs corresponding to the maximum value or minimum value of the first or second test parameter, and therefore the plot pair (13, 15), (14, 15), for example, is selected. Plot pair selection may be performed by the plot pair selecting means 118.

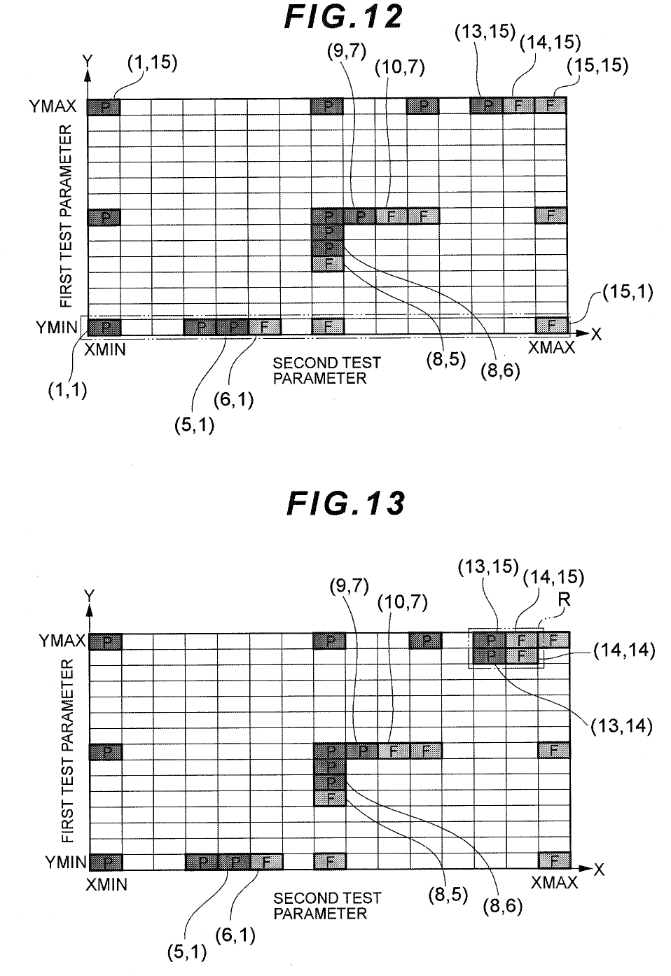

Next, the test results of a plot pair constituted by adjacent plots and located next to the two plots of the plot pair specified in the step S101 are specified (S103). More specifically, as shown in FIG. 13, the test result of a plot (13, 14) adjacent to the plot (13, 15) and the test result of a plot (14, 14) adjacent to the plot (14, 15) are specified using the plot pair (13, 15), (14, 15) as an origin. Here, the plot (13, 14) and the plot (14, 14) are adjacent plots. In the example shown in FIG. 13, the plot (13, 14) indicates a pass (P) while the plot (14, 14) indicates a fail (F).

Next, a plot pair constituted by adjacent plots but indicating different test results is selected from a region including the plot pairs specified in the steps S101 and S103 (S105), whereupon the test results of a plot pair constituted by adjacent plots and located next to the two plots of the plot pair specified in the step S105 are specified (S107).

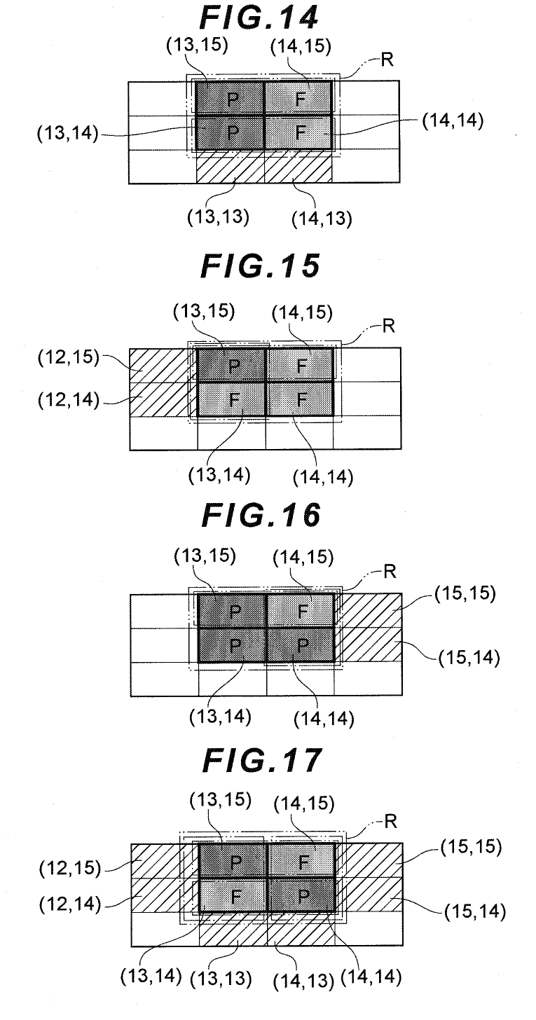

This step will now be described with reference to FIGS. 14 to 17. Here, FIGS. 14 to 17 are enlarged views showing a matrix in the vicinity of the coordinates of the plot pair (13, 15), (14, 15) specified in the step S101. FIG. 14 shows selection of the plot pairs shown in FIG. 13, while FIGS. 15 to 17 show selection of a different plot pair to those shown in FIG. 13.

First, selection of the plot pairs shown in FIGS. 13 and 14 will be described. In the step S105, first, a region R including the plot pair (13, 15), (14, 15) and the plot pair (13, 14), (14, 14) is selected, as shown in FIGS. 13 and 14. The region R may be selected by the region selecting means 120. When plot pairs constituted by adjacent plots but indicating different test results are selected from the region R, the combinations indicating different test results are the plot pair (13, 15), (14, 15) and the plot pair (13, 14), (14, 14), and therefore the plot pair selecting means 118 select the plot pair (13, 14), (14, 14), for example. Next, in the step S107, the test result of an adjacent plot (13, 13) to the plot (13, 14) and the test result of an adjacent plot (14, 13) to the plot (14, 14) are specified using the plot pair selected in the step S105 as an origin. Here, the plot (13, 13) and the plot (13, 14) are adjacent to each other. Note that both the plot (13, 13) and the plot (13, 14) indicate a fail (F).

In a modified example shown in FIG. 15, the combinations having different test results in the region R are the plot pair (13, 15), (14, 15) and the plot pair (13, 15), (13, 14), and therefore the plot pair (13, 15), (13, 14) is selected. Next, in the step S107, the test result of an adjacent plot (12, 15) to the plot (13, 15) and the test result of an adjacent plot (12, 14) to the plot (13, 14) are specified using the plot pair selected in the step S105 as an origin. Here, the plot (12, 15) and the plot (12, 14) are adjacent to each other.

In a modified example shown in FIG. 16, the combinations having different test results in the region R are the plot pair (13, 15), (14, 15) and the plot pair (14, 15), (14, 14), and therefore the plot pair (14, 15), (14, 14) is selected. Next, in the step S107, the test result of an adjacent plot (15, 15) to the plot (14, 15) and the test result of an adjacent plot (15, 14) to the plot (14, 14) are specified using the plot pair selected in the step S105 as an origin. Here, the plot (15, 15) and the plot (15, 14) are adjacent to each other.

In a modified example shown in FIG. 17, the combinations having different test results in the region R are the plot pair (13, 15), (14, 15), the plot pair (13, 14), (14, 14), the plot pair (13, 15), (13, 14), and the plot pair (14, 15), (14, 14), and therefore one plot pair is selected from the plot pair (13, 14), (14, 14), the plot pair (13, 15), (13, 14), and the plot pair (14, 15), (14, 14). Next, in the step S107, the test results of a plot pair constituted by adjacent plots and located next to the two plots of the plot pair selected in the step S105 are specified using the plot pair selected in the step S105 as an origin, as shown in FIG. 17. More specifically, the test results of one of the plot pairs illustrated in FIGS. 14 to 16 are specified.

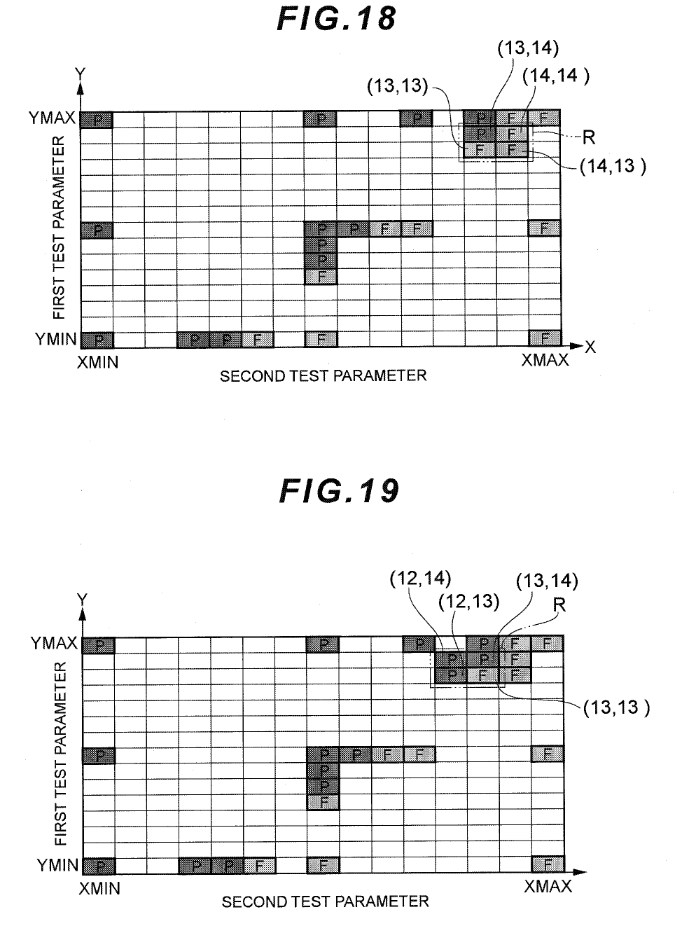

Next, the region R is shifted to include the plot pairs specified in the steps S105 and S107 (S109). The shifted region R may be selected by the region selecting means 118. More specifically, as can be seen from FIGS. 13 and 18, the region R is shifted such that the plot pair (13, 15), (14, 15) is excluded from the region R, the plot pair (13, 14), (14, 14) specified in the step S105 remains in the region R, and the plot pair (13, 13), (14, 13) specified in the step S107 is newly added. In other words, the region R is shifted to include 2×2 plot pairs.

Next, a plot pair constituted by adjacent plots but indicating different test results is selected from the shifted region (S111), whereupon the test results of a plot pair constituted by adjacent plots and located next to the two plots of the plot pair specified in the step S111 are specified (S113). More specifically, the combinations having different test results in the shifted region R shown in FIG. 18 are the plot pair (13, 14), (14, 14) and the plot pair (13, 14), (13, 13), and therefore the plot pair (13, 14), (13, 13) is selected. Next, as shown in FIG. 19, the test result of an adjacent plot (12, 14) to the plot (13, 14) and the test result of an adjacent plot (12, 13) to the plot (13, 13) are specified in the step S113 using the plot pair selected in the step S111 as an origin. Here, the plot (12, 14) and the plot (12, 13) are adjacent to each other. Note that both the plot (12, 14) and the plot (12, 13) indicate a pass (P).

Next, the region R is shifted further to include the plot pair selected in the step S111 and the plot pair specified in the step S113, as shown in FIG. 19 (S115).

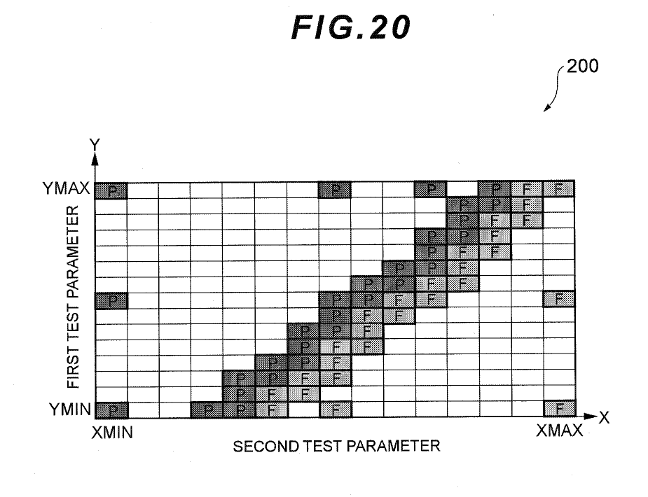

The steps S111 to S115 are repeated on the matrix until [the region R is] adjacent to the minimum value or maximum value plot of the first or second test parameter (S117). In other words, by executing plot pair selection in the shifted region R (S111), plot pair specification (S113), and further shifting of the region R (S115) repeatedly, the matrix shown in FIG. 20 can be formed. Note that in the example shown in FIG. 20, the final region R includes a plot pair (5, 2), (6, 2) and a plot pair (5, 1), (6, 1), as is evident from the above description.

Once plot pair specification through shifting of the region R is complete, a determination is made as to whether or not a plot pair constituted by adjacent plots but indicating different test results that is still to be tested exists (S119). In the example shown in FIG. 20, no new boundaries that can be specified by performing the steps from the step S103 onward using the plot pair specified in the step S101 as an origin exist, and it is therefore determined in the step S119 that no plot pairs which are still to be tested exist. Accordingly, the routine advances to a step S121. Alternatively, when a new boundary that can be specified by performing the steps from the step S103 onward using the plot pair specified in the step S101 as an origin exists, it is determined in the step S119 that a plot pair which is still to be tested exists, and therefore the steps from the step S101 onward are performed in relation to this plot pair. The steps S101 to S117 are executed repeatedly until it is determined in the step S119 that no plot pairs which are still to be tested exist.

Finally, a determination as to whether or not to modify the test condition (S121) is made. When there is no need to modify the test condition and the matrix based on the test results obtained under the initial test condition is sufficient, the routine is terminated. The finally obtained matrix 200 including the plots indicating test results may be stored in the storage means 130 by the test result outputting means 122 of the control means 110, for example, or may be displayed by the display means 104.

With the method of determining characteristics of a DUT according to this embodiment, as is evident from FIG. 20, a boundary between plots indicating different test results can be obtained on the matrix 200 by specifying a minimum number of plots. In other words, according to the method described above, the boundary is generated in sequence using a plot pair constituted by adjacent plots but indicating different test results as an origin, and therefore the pass/fail boundary can be obtained by specifying a minimum number of plots. As a result, the characteristics of the DUT can be determined in an extremely short test period.

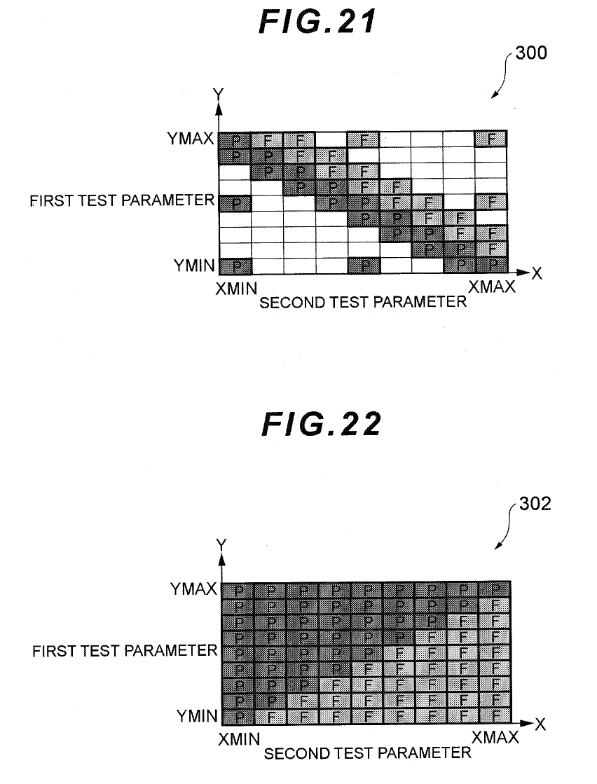

Next, referring to FIGS. 21 to 26, a modified example of this embodiment in which the test condition is modified in the step S121 and the characteristics of the DUT are obtained again on the same matrix will be described.

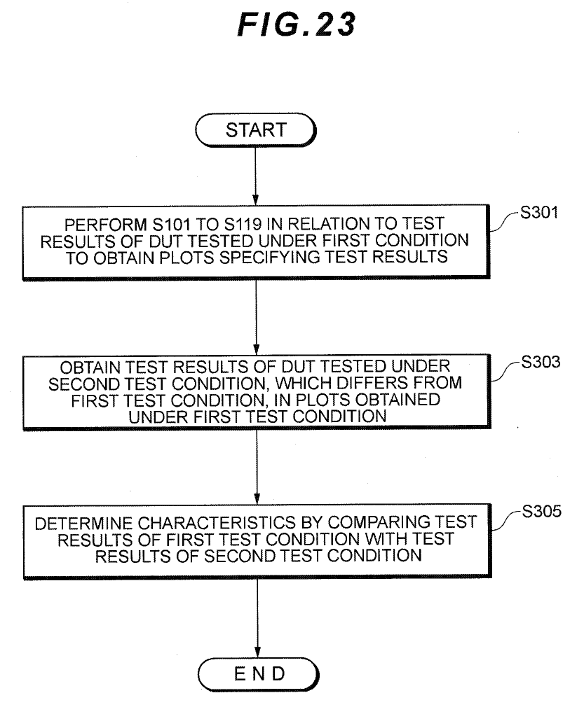

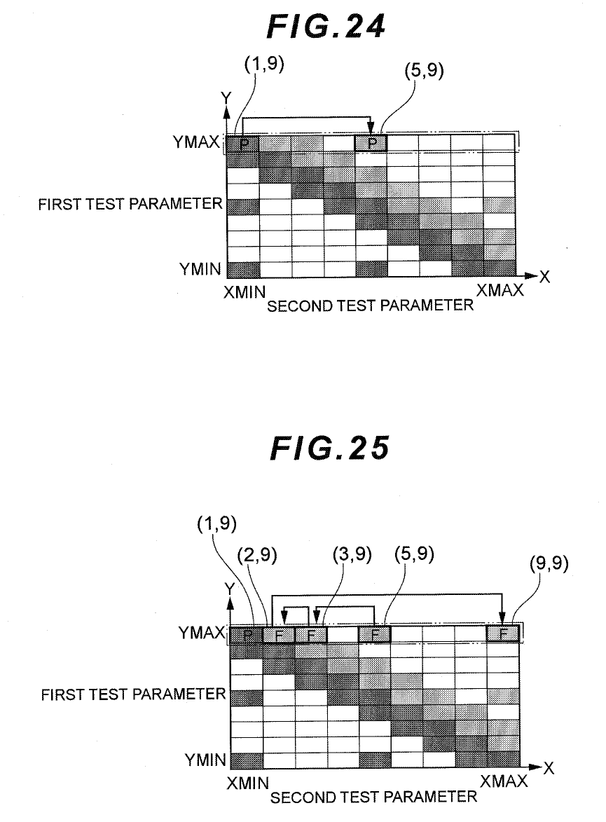

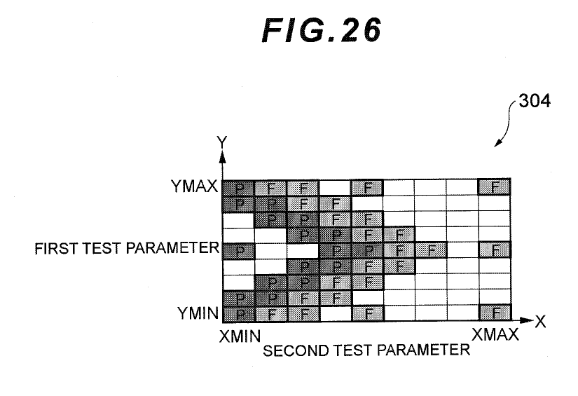

Here, FIG. 21 is a view showing a matrix obtained under a first test condition, and FIG. 22 is a view showing a matrix obtained under a second test condition in which the test results of all plots are specified. FIG. 23 is a flowchart showing a method of determining characteristics of a DUT according to this modified example, and FIGS. 24 and 25 are views showing examples of matrices obtained by applying the respective steps of the method of determining characteristics of a DUT according to this modified example. FIG. 26 is a view showing a matrix obtained finally under the first and second test conditions.

In this modified example, the DUT has a function according to which plots obtained in a plurality of (two, for example) tests are required. As shown in FIGS. 21 and 22, a matrix 300 obtained under a first test condition and a matrix 302 obtained under a second test condition are identical in terms of the first and second test parameters and so on, and differ only in the test results obtained by varying a shmoo subject of a plot. Here, the first test condition and second test condition may be combined such that under the first test condition, a predetermined pin is used, and under the second test condition, a different pin to the pin of the first test condition is used, for example. Further, on the matrices 300 and 302, nine plots are provided in the X direction and nine plots are provided in the Y direction so that a total of 81 plots is provided. Note that the content of the matrix 200 described above may be applied instead of the matrices 300 and 302.

First, as shown in FIG. 23, the steps S101 to S121 described above are executed in relation to test results of the DUT tested under the first test condition to obtain the plots specifying the test results (S301). In other words, the matrix 300 shown in FIG. 21 is obtained. In FIG. 21, a pass (P) symbol or a fail (F) symbol is attached to the plots having specified test results, whereas plots not having specified test results are left blank.

Next, the test results of the DUT tested under the second test condition, which is different to the first test condition, are obtained in the plots obtained under the first test condition (S303). The test results obtained under the first test condition are then compared with the test results obtained under the second test condition to determine the characteristics of the DUT (S305). This step may be applied during the steps S101 (including S201 to S217) to S121, as described above.

More specifically, first, as shown in FIG. 24, a single value of the first test parameter is selected, a single value of the second test parameter is selected, and the test result of a single plot (1, 9) selected thereby is specified, in accordance with the steps S201 and S203. In this case, the plot (1, 9) indicates a pass (P) under the first test condition (see FIG. 21) and indicates a pass (P) under the second test condition (see FIG. 22), and therefore, when the two results are compared, a pass (P) is obtained as a final test result.

Next, the test result of a plot (5, 9) is specified in accordance with the steps S205 and S207. In this case, the plot (5, 9) indicates a fail (F) under the first test condition (see FIG. 21) but indicates a pass (P) under the second test condition (see FIG. 22), and therefore, when the two results are compared, a fail (F) is obtained as a final test result.

A plot (3, 9) indicating a fail (F) and a plot (2, 9) indicating a fail (F) are then specified by performing the steps S209 to S215 repeatedly. In so doing, a plot pair (1, 9), (2, 9) constituted by adjacent plots but indicating different test results can be specified. Note that after the plot (2, 9) has been specified, the second test parameter may be displaced such that the maximum value XMAX and the minimum value XMIN are selected, whereby a plot (9, 9) indicating a fail (F) is specified.

The steps S201 to S217 are then repeated as necessary until the step S101 is complete, whereupon the remaining steps S103 to S121 may be performed in order to complete the test. Thus, the characteristics of the DUT can be obtained on the basis of the test results of the DUT under the first and second test conditions, as shown in FIG. 26.

Note that when a test result of the DUT tested under the second test condition is obtained in a plot that was not specified under the first test condition, the test result of this plot may be compared to an estimated test result on the basis of the test results of the DUT tested under the first test condition. For example, a plot in which the test result is estimated to be a fail (F) despite not being specified under the first test condition may be set as a fail (F) even if the test result obtained under the second test condition is a pass (P).

With the method of determining characteristics of a DUT according to this modified example, the characteristics of the DUT are determined by comparing the test results obtained under the first test condition with the test results obtained under the second test condition, and therefore a boundary between plots indicating different test results can be obtained by specifying a minimum number of plots. As a result, the characteristics of the DUT can be determined in an extremely short test period.

The examples described in the above embodiments of the present invention may be combined appropriately in accordance with the application or modified and amended for use, and the present invention is not limited to the above description of the embodiments. Embodiments including these combinations, modifications and amendments may also be included within the technical scope of the present invention, as is evident from the claims.

1. A method of determining characteristics of a device under test, in which test results indicating at least a pass/fail state of said device under test are used on a matrix in which plots defined by a combination of a first test parameter and a second test parameter for testing said device under test are arranged two-dimensionally, the method comprising the steps of:
(a) specifying at least one plot pair constituted by adjacent plots but indicating different test results on said matrix;
(b) specifying test results of a plot pair constituted by adjacent plots and located next to both plots of said plot pair specified in said step (a);
(c) selecting a plot pair constituted by adjacent plots but indicating different test results in a region including said plot pairs specified in said step (a) and said step (b); and
(d) specifying test results of a plot pair constituted by adjacent plots and located next to both plots of said plot pair selected in said step (c).

2. The method according to claim 1, further comprising a step of: (e) shifting said region to include said plot pair selected in said step (c) and said plot pair specified in said step (d).

3. The method according to claim 2, further comprising the steps of:
(f) selecting a plot pair constituted by adjacent plots but indicating different test results from said shifted region;
(g) specifying a plot pair constituted by adjacent plots and located next to both plots of said plot pair selected in said step (f);
(h) shifting said region further to include said plot pair selected in said step (f) and said plot pair specified in said step (g); and
(i) repeating said steps (f) to (h) until said region is adjacent to a plot of a maximum value or a minimum value of said first or second test parameter on said matrix.

4. The method according to claim 1, wherein said step (a) includes displacing a value of said second test parameter relative to a single value of said first test parameter to specify said test results of said plot pairs.

5. The method according to claim 4, wherein said step (a) includes displacing at least said second test parameter such that a maximum value and a minimum value are selected.

6. The method according to claim 5, wherein said step (a) includes the steps of:
(a1) specifying a test result of a plot selected from said second test parameter;
(a2) displacing said second test parameter such that at least one plot is skipped; and
(a3) specifying a test result of a plot selected by displacing said second test parameter.

7. The method according to claim 6, wherein said step (a) includes the steps of:
(a4) comparing said test results of said two plots;
(a5) displacing said value of said second test parameter in an opposite direction when, as a result of said step (a4), said two test results are different, and displacing said value of said second test parameter further in an identical direction when said two test results are identical;
(a6) specifying a test result of a plot selected by displacing said second test parameter; and
(a7) repeating said steps (a4) to (a7) until a plot pair constituted by adjacent plots but indicating different test results is specified.

8. The method according to claim 1, further comprising the steps of:
performing each of said steps in relation to test results from said device under test tested under a first test condition to obtain said plots specifying said test results;
obtaining test results from said device under test tested under a second condition, which differs from said first test condition, in said plots obtained under said first test condition; and
determining said characteristics by comparing said test results obtained under said first test condition with said test results obtained under said second test condition.

9. A non-transitory computer readable medium comprising software instructions that, when executed by a processer, perform a method of determining characteristics of a device under test, in which test results indicating at least a pass/fail state of said device under test are used on a matrix in which plots defined by a combination of a first test parameter and a second test parameter for testing said device under test are arranged two-dimensionally, said method comprising the steps of:
(a) specifying at least one plot pair constituted by adjacent plots but indicating different test results on said matrix;
(b) specifying test results of a plot pair constituted by adjacent plots and located next to both plots of said plot pair specified in said step (a);
(c) selecting a plot pair constituted by adjacent plots but indicating different test results in a region including said plot pairs specified in said step (a) and said step (b); and
(d) specifying test results of a plot pair constituted by adjacent plots and located next to both plots of said plot pair selected in said step (c).

10. (canceled)

11. The method according to claim 2, wherein said step (a) includes displacing a value of said second test parameter relative to a single value of said first test parameter to specify said test results of said plot pairs.

12. The method according to claim 3, wherein said step (a) includes displacing a value of said second test parameter relative to a single value of said first test parameter to specify said test results of said plot pairs.

13. The method according to claim 2, further comprising the steps of:
performing each of said steps in relation to test results from said device under test tested under a first test condition to obtain said plots specifying said test results;
obtaining test results from said device under test tested under a second condition, which differs from said first test condition, in said plots obtained under said first test condition; and
determining said characteristics by comparing said test results obtained under said first test condition with said test results obtained under said second test condition.

14. The method according to claim 3, further comprising the steps of:
performing each of said steps in relation to test results from said device under test tested under a first test condition to obtain said plots specifying said test results;
obtaining test results from said device under test tested under a second condition, which differs from said first test condition, in said plots obtained under said first test condition; and
determining said characteristics by comparing said test results obtained under said first test condition with said test results obtained under said second test condition.

15. The method according to claim 4, further comprising the steps of:
performing each of said steps in relation to test results from said device under test tested under a first test condition to obtain said plots specifying said test results;
obtaining test results from said device under test tested under a second condition, which differs from said first test condition, in said plots obtained under said first test condition; and
determining said characteristics by comparing said test results obtained under said first test condition with said test results obtained under said second test condition.

16. The method according to claim 5, further comprising the steps of:
performing each of said steps in relation to test results from said device under test tested under a first test condition to obtain said plots specifying said test results;
obtaining test results from said device under test tested under a second condition, which differs from said first test condition, in said plots obtained under said first test condition; and
determining said characteristics by comparing said test results obtained under said first test condition with said test results obtained under said second test condition.

17. The method according to claim 6, further comprising the steps of:
performing each of said steps in relation to test results from said device under test tested under a first test condition to obtain said plots specifying said test results;
obtaining test results from said device under test tested under a second condition, which differs from said first test condition, in said plots obtained under said first test condition; and
determining said characteristics by comparing said test results obtained under said first test condition with said test results obtained under said second test condition.

18. The method according to claim 7, further comprising the steps of:
performing each of said steps in relation to test results from said device under test tested under a first test condition to obtain said plots specifying said test results;
obtaining test results from said device under test tested under a second condition, which differs from said first test condition, in said plots obtained under said first test condition; and
determining said characteristics by comparing said test results obtained under said first test condition with said test results obtained under said second test condition.
